(19) United States
(12) Patent Application Publication
(10) Pub. No.: US 2023/0174258 A1
(43) Pub. Date: Jun. 8, 2023

(54) DYNAMIC TARGET IDENTIFICATION FOR AUTOMATED ITEM PLACEMENT

(71) Applicant: Intrinsic Innovation LLC, Mountain View, CA (US)

(72) Inventor: Wenzhao Lian, Fremont, CA (US)

(21) Appl. No.: 18/076,250

(22) Filed: Dec. 6, 2022

Related U.S. Application Data
(60) Provisional application No. 63/286,211, filed on Dec. 6, 2021.

(51) Int. Cl. B65B 5/08; G06T 7/13; G06V 10/25

(52) U.S. Cl. CPC B65B 5/08; G06T 7/13; G06V 10/25

(57) ABSTRACT

Methods, systems, and apparatus, including computer programs encoded on computer storage media, for automatically determining a location to place an object within a container. One of the methods includes receiving an image of a container that contains one or more objects. One or more respective masks that define the boundaries of the one or more objects within the container are generated. Empty spaces in the container are determined based on the one or more masks, and a bounding box of the mask of an additional object to be placed in the container. The empty spaces are ordered according to respective distances from a container target. A target empty space for the additional object is selected according to the ordering.

### CROSS-REFERENCE TO RELATED APPLICATIONS

This application claims the benefit under 35 U.S.C. § 119(e) of the filing date of U.S. Provisional Patent Application No. 63/286,211, filed on Dec. 6, 2021, entitled “Dynamic Target Identification for Automated Item Placement,” the entirety of which is herein incorporated by reference.

### TECHNICAL FIELD

This invention relates generally to the automated packing field, and more specifically to a new and useful item insert planner in the automated packing field.

### BACKGROUND

In configuration-sensitive box packing tasks, it is desired that each box is packed as close as possible to a packing template. However, due to non-perfect operations from upstream operators/machines, the objects already inside the box might have minor translational or rotational error. Commanding the robot to always place the item to a predefined configuration will lead to collisions in such cases.

Thus, there is a need in the automated packing field to create a new and useful item insert planner that is flexible while being consistent

### BRIEF DESCRIPTION OF THE DRAWINGS

FIGS. 1A-G illustrate different aspects of the techniques described in this specification.

FIG. 2 is a flowchart of an example method for object detection and target planning.

FIG. 3 is a schematic representation of an example system.

FIG. 4 is a flow diagram showing how a system can be continually process items in sequence.

FIG. 5 illustrates an example system having a manipulator and a detection sensor that are both shifted by an actuation system.

FIG. 6 is a flow diagram of an example method.

FIG. 7 is a flowchart of an example process for placing an item in a container at a selected item destination.

FIG. 8 is a flowchart of another example process for placing an item in a container at a selected item destination.

Like reference numbers and designations in the various drawings indicate like elements.

### DETAILED DESCRIPTION

The following description of the preferred embodiments of the invention is not intended to limit the invention to these preferred embodiments, but rather to enable any person skilled in the art to make and use this invention.

1. Overview.

The insert planning method includes, for an item to be inserted into a container: detecting objects within the container; determining a rotated coordinate system based on the objects; determining a container target within the rotated coordinate system; determining object bounding boxes aligned with the rotated coordinate system; determining an item bounding box aligned with the rotated coordinate system; and determining an item destination based on the container target, the object bounding boxes, and the item bounding box. The insert planning method functions to plan a collision-free insertion pose (e.g., as close as possible to a desired configuration).

2. Benefits.

The insert planner (and/or insert planning method) can confer several benefits over conventional systems.

First, variants of the insert planner can operate in real time or near real time. This can offer a significant advantage when packing boxes on a moving conveyor or similar system, because the system can adjust for minor shifts in the objects (obstacles) in the box as it is placing an item. This can be enabled by simplification of the container-, item-, and/or obstacle-occupied volumes to 2D or point representations. This simplification can further enable the system to operate with minimal computing power.

Second, variants of the insert planner can leverage 3D meshes of objects, which can enable better segmentation and empty space identification. This can improve space utilization in the container.

Third, variants of the insert planner can use a packing template to closely match a desired arrangement of the container. This allows the system place items in specific locations with a high degree of repeatability, which is important in configuration sensitive packing tasks.

Fourth, variants of the insert planner can flexibly adhere to a packing template. This can address the real challenges of packing which ideal versions (that insert plan according to an immutable predefined configuration) neglect, such as imperfect operations of upstream workers/machines and small rotational/translational errors in object placement. Immutable predefined configurations cannot adapt to these problems, which can damage goods or equipment and can result in improperly packed boxes.

Fifth, variants of the insert planner can improve volumetric packing efficiency, reducing packing waste. This can also reduce shipping costs associated with packing material and container size.

However, the insert planner can confer any other suitable set of benefits.

3. System

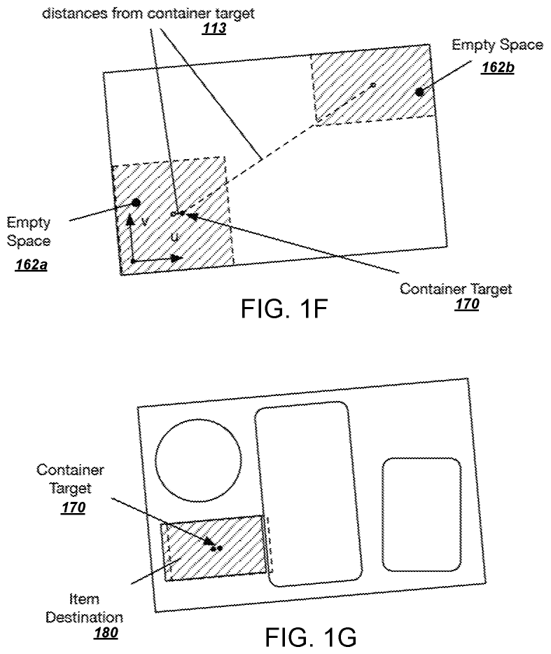

FIG. 3 is a schematic representation of an example system 300. The system 300 can include a detection sensor 310 to identify objects in each container 320 when the container enters a packing region 360, a manipulator 330, e.g., a robotic arm, to place items in the container 320, and a processing system 340 to plan and execute packing operations.

The system can be used with a container holding obstacles/items in the container (e.g. items, objects), an actuation system 350, e.g., a conveyor belt, for positioning the container in view of the object detector, and/or any other suitable component. The system can be used with: a packing template indicating a preferred layout of an item(s) in the container, bounding boxes indicating the locations of items, obstacles, and components, and/or any other suitable data structure.

The system functions to plan and execute item insertion at item destinations within collision-free-empty spaces within containers (e.g. boxes). The system can be part of a packing line, an independent automated system, operated by a user, and/or operate in any other appropriate application.

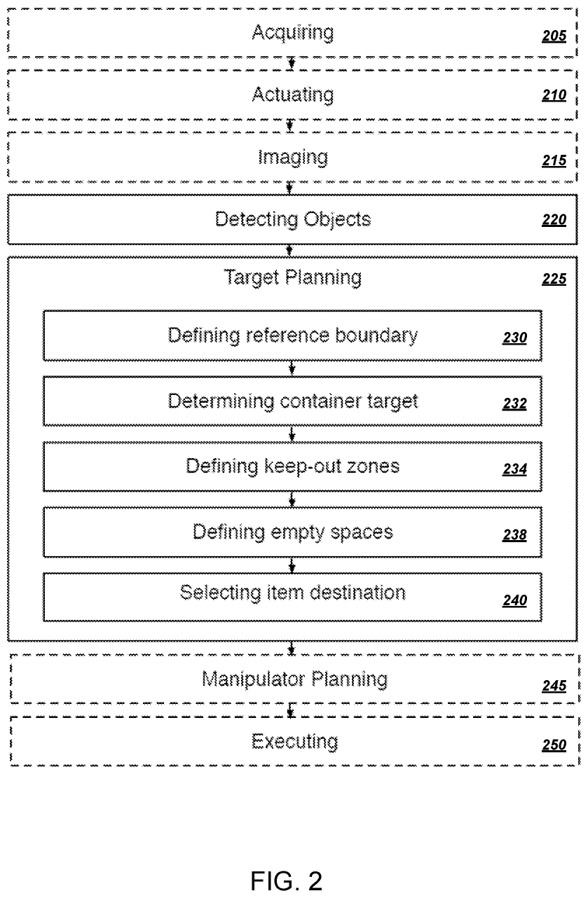

FIG. 4 is a flow diagram showing how the system 300 can be used to continually process items in sequence. The system can repeatedly perform object detecting 410, then target planning 420, then manipulator planning 430, and executing 440. In parallel, the system can be acquiring an item 450 to place into the container. When the execution phase 440 has completed, the system can move on to the next object or next container.

### Detection Sensor

The detection sensor functions to sample measurements of objects in the container, and can optionally sample measurements of the item, the container (e.g., container walls), and/or any other suitable component.

The detection sensor is can be arranged above the container, but can additionally or alternatively be arranged to the side of the container, below the container (e.g., wherein the container is transparent), or at any suitable position relative to the container. The detection sensor is preferably oriented facing downward (e.g., giving a top view of the container), with a viewing vector (e.g., perpendicular the view plane) aligned with the container cavity bottom's normal vector and/or packing surface's normal vector, but can be arranged at an angle or be otherwise oriented.

The detection sensor can be statically mounted relative to a packing region, but can additionally or alternatively be statically mounted relative to: the container, the actuation system, the manipulator, and/or any other suitable component or reference frame.

The detection sensor is associated with a sensor reference frame (e.g., coordinate system). The relationship between the sensor reference frame and the container reference frame, the item reference frame, the packing region reference frame, and/or any other suitable reference frame is preferably known and/or calculable, but can alternatively be unknown.

The system can include one or more detection sensors of the same type or different type. In one example, the multiple detection sensors (e.g., three) may be arranged in an array (in any geometry or appropriate location) orthogonal to the top plane of the packing region (or the plane of the packing region for a 2D packing region).

In one variation, the system includes multiple stations (e.g., detection points), wherein each station includes one or more detection sensors and/or packing regions. Each station can be associated with a predetermined set of items to be positioned within the container. However, the system can include a single station (e.g., for one or more items), or be otherwise configured.

The detection sensor can be a visual sensor, but can alternatively be an acoustic sensor (e.g., radar), or be any other suitable sensor type. The detection sensor can include one or more: 3D sensors, 1D sensors, 2D sensors, and/or any other suitable sensor. The detection sensor can be a camera, but can additionally or alternatively be a scanner, projector, probe, or any other suitable sensor. The 3D camera is preferably a stereo camera (e.g., including two or more 3D cameras), but additionally or alternatively a sheet of light triangulator, structured light scanner, modulated light scanner, time of flight camera, interferometer, range imager, or any other suitable 3D camera.

The detection sensor can additionally or alternatively include one or more depth sensors. The depth sensor can be a structured light projector, a 2D imager sampled at the same wavelength, and/or any other suitable camera capable of capturing a structured light pattern. The depth sensor can additionally or alternatively include a time of flight (TOF) 3D scanner, laser scanner, or any other suitable 3D scanner.

The detection sensor can operate at any suitable data rate or resolution. In a preferred embodiment, the frame rate is faster than the minimum response time of the manipulator. In a preferred embodiment, the detection sensor captures better than 1 mm resolution, but variants can operate at any suitable resolution.

### Manipulator

The manipulator of the system functions to retain, move, and place items into the container at the item destination.

The manipulator can include: a robotic arm, gantry, dispensing system with at least 1 degree of freedom (e.g., 4 degrees of freedom, 2-4 degrees of freedom, 3 degrees of freedom, etc.), and/or any other suitable manipulator.

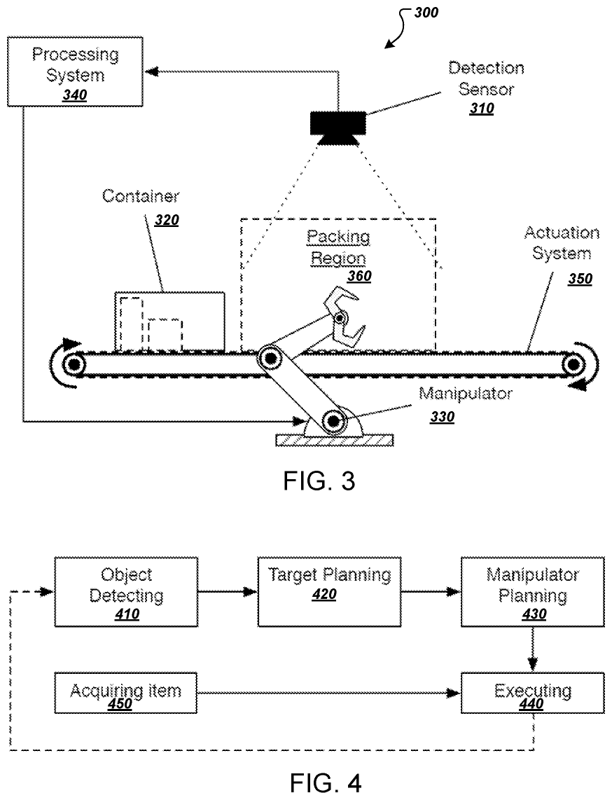

The manipulator may further include an optional end effector. Examples of end effectors that can be used include: a grabber, dispenser (example shown in FIG. 5), container, actuated hand, vacuum, suction cup, or any other suitable end effector. In variations, the manipulator may be calibrated or otherwise operate in a known location of manipulator relative to the detection sensor (i.e., manipulator position/orientation known within the sensor reference frame).

### Processing System

The processing system of the system functions as the insert planner (e.g., and executes all or part of the method described below). The processing system can optionally control, monitor, and/or execute packing operations (e.g., by controlling manipulator operation, container manipulation, etc.).

The processing system can be local or remote. The processing system may include a micro-controller, computer, cloud server, memory systems, and/or any other suitable means of data processing. The processing system may operate asynchronously or synchronously, discretely or continuously, the data/processing may be aggregated or distributed, or the processing system may operate in any appropriate manner. The processing system can be communicatively coupled to the detection sensor, the manipulator, and/or any other suitable component.

### Container

The system can be used with one or more containers, which function to enclose and retain the item and a set of obstacles (e.g., pre-placed items).

The container may be a box, tray, plate, bowl, container, enclosure, packaging, or other appropriate plane or volume. The container may be constructed of cardboard, plastic, metal, or any other appropriate material.

The container is can be a rectangular prism (e.g., cardboard shipping box) with the bottom, front, right, left, and back faces fully enclosed by cardboard and the top face of the container is open (accessible for item placement). Any side of the container may be open, closed, able to articulate between open/closed, or partially open or closed (e.g., a removable access panel), or otherwise configured.

In a first example, the container is a cardboard shipping box (e.g., 12″×8″×4″ dimensions) and has an object (e.g., book) contained therein. In a second example, the container is a takeout container and has several food retention compartments. In a third example, the container is a plastic tray (e.g., a flat sheet with no walls) that can be vacuum sealed.

### Obstacles

The system can be used with a set of obstacles. Obstacles can be items that were previously placed into the container, but can be portions of the container itself, or be any other suitable physical obstacle that the item could collide with. The obstacles can be positioned and oriented within the container in any geometry, or using the same or different method(s) as described below.

### Packing Template

The system can be used with a set of packing templates, which function to define a reference location of an item relative to the container and/or the other obstacles within the container. The packing template can be a planned layout of one or more reference locations within a 2D area or a 3D space, wherein the reference location is a desired destination of a particular item/object with respect to the container. The reference location can be a point, an area, and/or a volume.

In a first variation, a user inputs the packing template into the system. In a second variation, the packing template is learned. For example, a container with an item arranged in the reference location is presented to the detection system; the container and the item are detected with object detectors; and the item pose with respect to the container reference frame is determined. In one example, the relative item pose with respect to the container reference frame is represented as:

T_{item_box}≡(x⁰,y⁰,z⁰,φ⁰,θ⁰,ψ⁰).

However, the packing template can be otherwise determined.

### Bounding Boxes

The system can be used with a set of bounding boxes, which function to abstract the volume (in 3D) or the area (in 2D) occupied by an object or component to a standard shape (e.g., triangle).

The system can define zero, one, or more bounding boxes for: objects (e.g., items, obstacles, containers), object sets (e.g., multiple object regions, such as in the sensor or container reference frames), candidate placement regions (candidate boxes), target locations, manipulator arms, manipulator end effector, container walls, and/or any other suitable component.

The standard shape can be: a rectangle, a triangle, a hexagon, an arbitrary regular polygon (e.g., with even number of sides), and/or any other suitable shape. The standard shape is preferably represented by two coordinate points along a predetermined axis/line (e.g., a predetermined diagonal of a rectangle), but can additionally or alternately be represented by three or more points, a line, a boundary, an area, a region, and/or any other suitable set of representations. In the most preferred embodiment, the shape is a rectangle.

The bounding boxes are preferably orthogonally aligned with a rotated and/or translated coordinate system (u,v), additionally or alternatively sensor coordinate system (x,y), or otherwise aligned. In a variation, one side of a standard shape is aligned with one of the coordinate system axes (e.g., the u-axis). In second variation, one side of a standard shape is aligned with one of the axes of the container reference frame.

In an example, the bounding box is the minimum box that encloses the entirety of the subject of interest (e.g., object, item, set of obstacles, obstacle, candidate space, empty space, collision-free-empty space, etc.), but can additionally or alternatively have a predetermined size, predetermined shape, and/or be otherwise defined. A specific example of this is the item bounding box, which may be defined as the minimum box which encloses the item (in the sensor reference frame, in the container reference frame, etc.), but additionally or alternatively may have a predetermined size (e.g., include a boundary offset), predetermined shape (e.g., a circle, a rectangle, etc.), or be otherwise defined. The item bounding box may additionally be defined in any way to avoid collisions of the item and/or manipulator with other objects/obstacles/container (e.g., adding an offset which considers the motion of the manipulator during item placement, leaving a perimeter around the item, or any other suitable technique to avoid collisions).

### Actuation System

The system can optionally include an actuation system, which functions to position the container in view of the object detector and/or move multiple instances of the container relative to the packing region. The actuation system preferably moves the container (e.g., box) to the manipulator, but can otherwise actuate the container. The actuation system can be a linear system, rotational system, combination thereof (e.g., a conveyor, belt system, pneumatic/hydraulic actuation, rotary actuation, linear actuation, etc.), and/or any other suitable actuation mechanism.

In one variation, the actuation system orients the detection sensor by translating, panning, tilting, or otherwise re-positioning to capture sensor data in the packing region. In an example, the detection sensor and manipulator are both attached to movable assembly (e.g., actuation system moves the sensor reference frame and all components whose operations are tied to it).

In a second variation, a user manually moving container into place. In this variation, the user controls discretized container motions/detections (e.g., with all container detection operations happening in a similar region or in an arbitrary region), or continuous motion of the container.

In a third variation, the system can include one or more detection points for capturing sensor data on the container.

However, the system can include any other suitable set of components.

### 4. Method

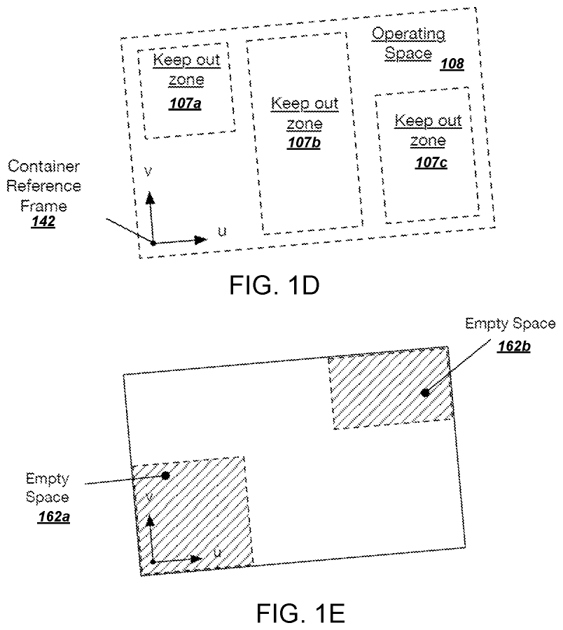

FIG. 2 is a flowchart of an example method for object detection and target planning. Target planning (225) may include the sub-steps of: defining a reference boundary (230), determining a container target (232), defining keep out zones (234), defining empty spaces (238), and selecting an item destination (240). The selecting item destination sub-step may optionally include: checking collisions and checking the offset of an empty space. The method may optionally include: acquiring an item (205), actuating the item (210), imaging the packing region (215), planning the manipulator path (245), and executing the manipulator path (250), and/or any other suitable process.

The method functions to identify an item destination in a container where an item may be placed without colliding with existing obstacles (e.g., objects in the container).

All or portions of the method can be performed by the processing system, using the system components discussed above, but can additionally or alternatively be performed by any other suitable computing system.

### Acquiring Item

The method can optionally include acquiring the item functions to retain and control an item for future placement. The item is preferably acquired (e.g., retained) by the manipulator, but can be otherwise acquired. In variations, this step can be further controlled by the processing system, by a user (e.g., user loading item(s) into a dispenser), and/or otherwise controlled.

The item can be acquired: before, during, or after: the actuating step, the object detection step, the target planning step, and the manipulator planning step; occur before the execution step; and/or can occur at any suitable time(s) relative to other steps, inputs, or executable tasks.

Acquiring the item can include the manipulator grabbing, lifting, pinching, enclosing, attaching via suction/vacuum pressure, or otherwise retaining or controlling the item in an initial position. In a specific example, the manipulator controls the item with an end effector. However, the item can be otherwise acquired.

### Actuating

The method can optionally include actuating the container, functions to position the container within the detection sensor's field of view and/or within the packing region.

The actuating step can occur: before, during, or after the acquisition step; occur before or during object detection, target planning, manipulator planning, and execution steps; and/or be performed at any suitable time(s) relative to other steps, inputs, or executable tasks.

The actuating step may be a single operation, a set of discretized operations, or a continuous operation (example of this is described above with reference to FIG. 3).

In a first variation, the container can be actuated by the actuation system. In some variations, this step can be further controlled by the processing system, by user input, and/or otherwise controlled.

In a second variation, this step may be performed wholly or in part by a user. For example, the user can: place container(s) in a packing region; control operation of a belt or linear actuator; control detection points (e.g., control where detection sensors are focused, change orientation/position of detection sensors, or otherwise control detection points); or otherwise control container actuation.

In a third variation, the actuation step involves translating, panning, and/or tilting the detection sensor towards the packing region, or similarly shifting the packing region along with the detection sensor over to the container (example shown in FIG. 5).

FIG. 5 illustrates an example system 500 having a manipulator 530 and a detection sensor 510 that are both shifted by an actuation system 550. The packing region 560 is defined as the region beneath the manipulator 530 and detection sensor 510 subsystems. The processing system 540 can control the actuation system 550 to shift the manipulator 530 and the detection sensor 510 to the left until the packing region 560 overlaps the container 520. The processing system 540 can then cause the manipulator to place an object into the container 520.

However, in some other implementations, the container can be otherwise positioned relative to the detection point and/or packing region.

In a first example of the actuating step, a container is on a belt and is in constant motion.

In a second example of the actuating step, a container moves on a belt and stops when it arrives in a predetermined position, when the detection sensor identifies the container is in an appropriate position (e.g., in view of detection sensor, in the packing region, at a detection point, etc.), or when the a user inputs a command.

In a third example of the actuating step, the container is stationary (e.g., on a platform or staging area) and the actuation system moves the detection sensor and the manipulator moves to the container.

### Imaging

Imaging the packing region functions to sample measurements (e.g., data) of the container(s) (e.g., with or without one or more obstacles contained therein) within the packing region. Imaging the packing region can optionally sample measurements (e.g., data) about the item, the manipulator, the actuation system, and/or any other suitable component.

Preferably, the imaging step is performed by the detection sensor, but can additionally or alternately be performed wholly or in part by any appropriate component. In a more preferred embodiment of the imaging step, a single detection sensor samples a top view of the packing region. Additionally or alternately, the imaging step may be performed by a single or multiple detection sensors arranged in any suitable pattern or geometry. The detection sensor communicates imaging data to the processing system.

Imaging data may be images (e.g., image frames, photos, etc.), a point cloud, mesh, video, or any other suitable data in any appropriate format. When sampling both the container and the item, the imaging data can capture both in the same frame (or point cloud, video, etc.), in a different frame (from the same sensor or a different sensor), or by any other suitable technique.

The imaging step can occur before, during, or after: the actuating step; occur before the object detection step, the target planning step, the manipulator planning step, and the execution step; and/or can occur at any suitable time(s) relative to other steps, inputs, or executable tasks.

### Object Detecting

Detecting the object functions to transform the measurements (e.g., images) into simpler object region representations in the sensor reference frame. The object(s) are preferably detected by the processing system from the measurements, but can be otherwise detected.

The object detecting step can occur: before, during, or after the acquiring item step; occur during or after the actuating step and the object detecting step; occur before the target planning, manipulator planning, and executing steps; and/or occur at any other suitable time.

The object region representation output by the object detecting step is preferably two-dimensional, but can additionally or alternatively be: three-dimensional, a vector or array, one or more points, and/or any other suitable data representation.

Object region representations that can be used include: a binary object mask, 3D object mesh(es), an object bounding box, an object boundary (e.g., 2D boundary), and/or any other suitable representation.

In a first variation, the detecting the object(s) may include: generating a container mesh, including meshes of the objects within the container (e.g., with the poses of the respective objects within the container) and optionally a mesh for the container itself; determining a depth map from measurements (e.g., images); projecting container mesh (and/or points thereof) onto the depth image; and generating a binary mask based on the projection.

The container mesh and/or object meshes can be determined from the measurements, retrieved from an object database, and/or otherwise determined. In one embodiment, a point cloud is generated from the container image output of the imaging step. The mesh can be a convex hull or be any other suitable mesh.

The object poses within the container are preferably determined from the measurements (e.g., images), but can additionally or alternatively be determined from auxiliary measurements (e.g., from a depth sensor), by the item itself (e.g., using on-board sensors), and/or otherwise determined.

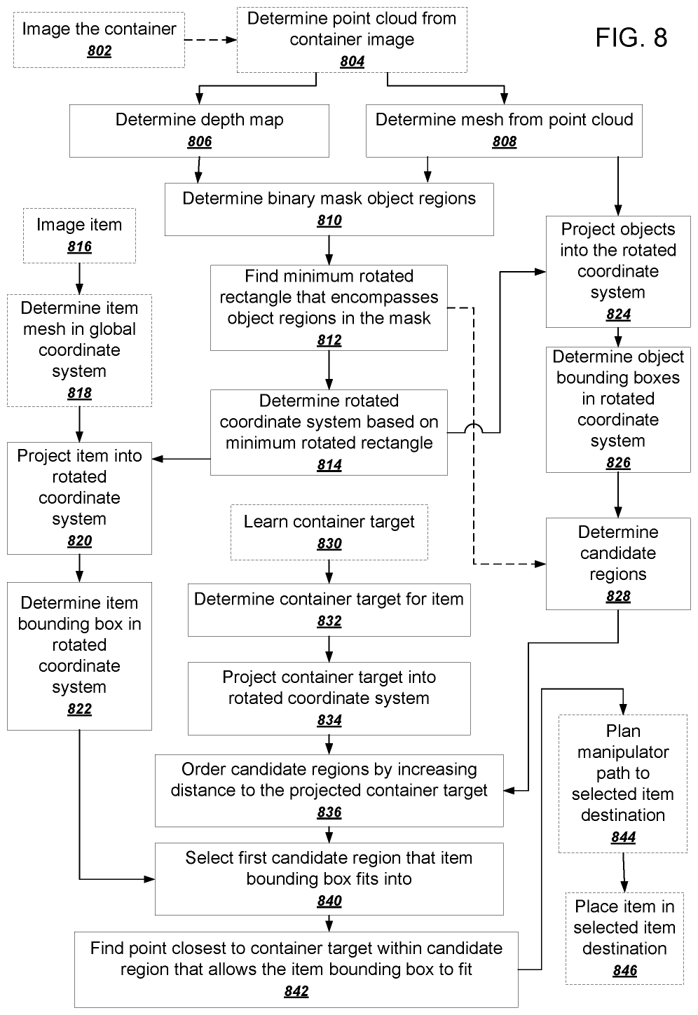

The depth image can be determined using a neural network (trained on at least one image of objects in a similar container), be determined from the container mesh (example shown in FIG. 8), be determined from a point cloud, be output by the detection sensor, or be otherwise determined. In this embodiment, the depth map is generated from one or more 2D images generated in the imaging step.

The binary mask can be determined: from the depth image (e.g., alone), from a combination of the depth image and the container mesh, or determined using any other suitable data. In examples, the binary map can be determined by: identifying the overlapping regions of the depth image and the container mesh; applying a threshold value to the depth image; otherwise filtering the depth image; and/or otherwise determining the binary map.

In a second variation, detecting the object generates an object boundary from the depth image and/or 2D image (e.g., using CNNs, DNNs, viola Jones framework, SIFT, HOG methods, SSD, YOLO, etc.).

However, the object can be otherwise detected.

Item detection and/or item data generation (including item detection, mesh generation, pose determination, item (object) regions/boundaries etc.) can be performed similarly to object detection and/or object data generation (e.g., as described above), or be otherwise determined.

### Target Planning

The target planning step outputs a target item pose and/or manipulator pose (e.g., manipulator hand pose). The pose can be in the manipulator reference frame, the sensor reference frame, and/or in any other suitable coordinate system.

In some implementations, the target planning step: occurs before, during, or after the acquiring item step; occurs during or after the actuating step; occurs after the object detection step; occurs before the manipulator planning and executing steps; and/or can occur at any suitable time(s) relative to other steps, inputs, or executable tasks.

In some implementations, the target planning step is performed by the processing system and takes in inputs of object data (e.g., binary object mask or object boundary), the item data, and optionally a packing template.

### Defining Reference Boundary

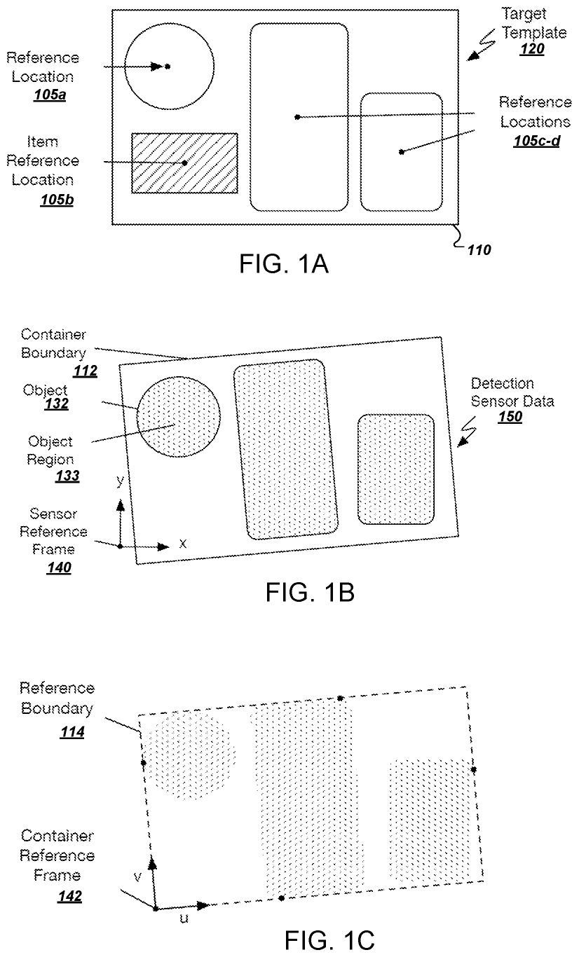

FIG. 1A illustrates reference locations 105a-d within an example container 110.

FIGS. 1B and 1C illustrate defining a reference boundary 114 from detection sensor data 150. In FIG. 1B, the actual container boundary 112 is rotated relative to the sensor reference frame 140. This can occur due to inaccuracies in a conveyor belt, placement, or any other appropriate manufacturing process.

Defining the reference boundary 114 functions to define a rotated coordinate system (e.g., the container reference frame 142) based on object regions 133 of objects 132 detected from the sensor data. Additionally or alternately, the rotated coordinate system 142 may be determined in any appropriate manner. In some implementations, a new instance of defining the reference boundary 114 is executed for each new container instance, but can additionally or alternately be executed periodically, based on a user input, or in any other appropriate manner.

In some implementations, the reference boundary 114 is defined by the minimal bounding box which encloses all object regions 133 (example shown in FIG. 1B; a minimum-sized bounding box which circumscribes: all object regions across all box orientations, a quantized set of orientations, a cost function to determine the minimum size and minimum orientation and/or any other appropriate means of defining a bounding box; etc.). In one example, object regions 133 are pulled from a binary object mask. In another variant, object regions are bounding boxes, 3D object meshes, or any other data representing object locations. In some variants, the sides of the box are considered obstacles (e.g., sides define an object region, or sides represent a container boundary which is considered when evaluating collisions). In some variants, the sides of the box are not considered obstacles.

In some implementations, the edges (e.g., sides) of the reference boundary 114 define the container reference frame 142. In other words, the axes of the container reference frame can be aligned with right angles of the reference boundary 144 The container reference frame (e.g., the origin of the u,v coordinate system) may be located at the lower left corner of the minimal bounding box as shown in FIG. 1C; located in the centroid of the bounding box with axes parallel to the sides; located in any other location inside, outside, on the perimeter of the bounding box; or in any other appropriate location with any appropriate orientation relative to the reference boundary. Additionally or alternately, the u axis of the container reference frame may be aligned parallel (or colinear) to one of the sides (or edges) of the reference boundary or in any other appropriate orientation. In an example embodiment, the u axis is colinear with the bottom edge of the reference boundary and the v axis is colinear with the left edge of the reference boundary. Additionally or alternately, the container reference frame may be defined in any appropriate manner.

In some implementations, the defining reference boundary step happens before the step of determining keep out zones. Alternately the defining reference boundary step can happen after the step of determining keep out zones, or at any other appropriate time in relation to any of the target planning steps.

In some implementations, the area enclosed by the container in the container reference frame is the operating space 108 (example shown in FIG. 1D). Alternately, the area enclosed by the minimal bounding box (in container reference frame) is the operating space. In another variant, the operating space is any geometry, enclosure, or boundary related to the item, an object or object region, a set of objects or object regions, a container, the manipulator, an area in the proximity of the manipulator, or any combination of these elements/regions in the container reference frame.

### Determining Container Target

In some implementations, the determining container target step functions to identify the container target to use for target planning.

The container target may be a reference location (example reference locations 105a-d shown in FIG. 1A) in the packing template 120 (in the sensor reference frame), but additionally or alternately be any point or area in any appropriate coordinate system or reference frame. The container target may be determined by projecting a point or area from the sensor coordinate frame or packing template into the container reference frame, but additionally or alternately may be determined by any other suitable technique.

The container target may be determined by calculating an error minimizing transformation that maps a set of objects (e.g., object regions, object data, etc.) in the container reference frame to a corresponding set of reference locations in the packing template, and then applying the inverse transformation on the item reference location in the packing template to generate the container target in the container reference frame.

The container target may be determined based on the item (e.g., predetermined target or reference location associated with the item), selected (e.g., manually), or otherwise determined. In an alternate embodiment, the container target or predetermined target can be: learned, received from a database or other endpoint, or otherwise determined. In one example, the container target (e.g., a point on the packing template, an area on the packing template, etc.) is learned from a container, with an item placed inside, in view of the object detector. The container and item are detected with the object detector, and thus the relative pose of the item may be determined in the container reference frame (or sensor reference frame). In another version of this embodiment, the container target includes a target defined by a bounding box or a reference location (e.g., center/centroid of a bounding box in a global, sensor, reference, or container coordinate frame).

### Defining Keep-Out Zones

FIG. 1D illustrates keep-out zones 107a-c within an operating space 108.

Defining keep-out zones functions to define bounding boxes which indicate regions where an item should not be placed, but can additionally or alternately be defined in any appropriate manner. In some implementations, the obstacle bounding boxes are defined within the container reference frame 142, but can additionally or alternately be defined in any appropriate manner. In some other implementations, the keep-out zones 107a-c are rectangular obstacle bounding boxes determined within the container reference frame (the u,v coordinate system), with the sides of the keep out zones are aligned with the axes of the container reference frame. Additionally or alternately the keep-out zones can be any appropriate geometry or be oriented in any way relative to the container reference frame coordinate system.

In a first variant, for each obstacle in the operating space 108, the step of defining keep-out zones 107a-c includes: projecting the object mesh into the container reference frame and defining object bounding boxes around each of the projections, wherein the object bounding boxes are aligned with the axes of the container reference frame.

In a second variant, bounding boxes are identified around each object region (e.g., in the binary object mask, from the images, etc.) and then are transformed into the container reference frame.

In some variants, the defining keep-out zones step may further include transforming (x,y) object coordinates (or regions, data, etc.) from the sensor (or global) coordinate frame into the (u,v) coordinate system.

However, the keep-out zones can be otherwise determined.

### Defining Empty Spaces

FIG. 1E illustrates empty spaces 162a-b within an operating space 108. In some implementations, the step of defining empty spaces functions to identify distinct regions the operating space which can provide options for item placement (example shown in FIG. 1E). Empty spaces are preferably rectangles, but can be any other shape. For example, the empty spaces 162a-b are rectangles within the operating space 108 that are aligned with the container reference frame 142. Empty spaces can be overlapping or non-overlapping. Empty spaces are preferably represented by the minimum and maximum points along the diagonal of a rectangle in the container reference frame, but can additionally or alternately be defined as any shape (e.g., circle, triangle, hexagon), with any appropriate size, and/or in any other appropriate manner.

In some implementations, the empty spaces are a set of rectangles (and/or other bounding box shapes) defined by the boundaries of the keep out zones (which may or may not include the container sides/edges) in the container reference frame. In some implementations, empty spaces do not overlap or intersect any keep-out zones, but can additionally or alternately be defined in any other way.

In a first variant, the empty spaces are a set of quantized regions within the operating space. Empty spaces may all have the same side lengths as the item bounding box (same length and width and/or same length and width with sides flipped (rotated 90 degrees)). The empty spaces preferably have the same pose as the container target, but can alternatively have different poses (e.g., be rotated orthogonally). Additionally or alternately the empty spaces do not intersect keep-out zones.

However, the empty spaces can be otherwise defined.

### Selecting An Item Destination

FIG. 1F illustrates computing distances 113 between empty spaces 162a-b and a container target 170. In some implementations, selecting the item destination functions to output an item destination 180 for the item based on the container target 170, item bounding box, and the set of empty spaces. The item destination 180 is preferably an empty space (or a point within an empty space) which fits the item or item bounding box (e.g., equal to or larger than the item bounding box), is as close as possible to the container target 170 and which does not collide with the existing objects within the container (e.g., selected candidate region does not intersect keep-out zones). In one variation, the box walls (sides, edges, etc.) can also be considered an obstacle (i.e., object) or can bound the operating space.

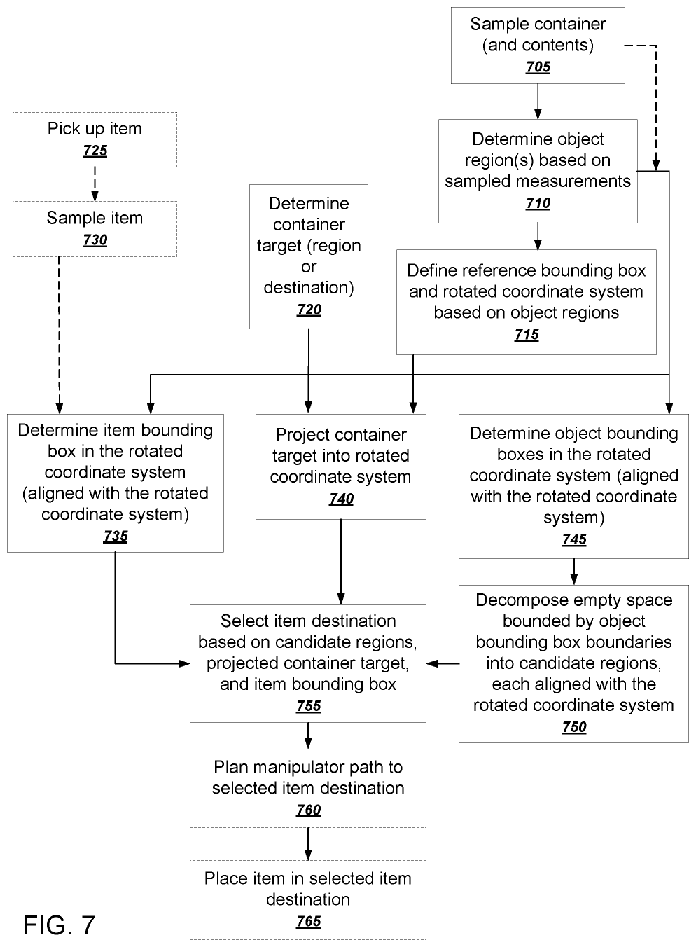

In a first variant, the empty spaces are ordered by increasing distance from the container target 170 (example shown in FIG. 7)—this will be referred to as the objective order. In an example, the empty spaces are ordered based on the centroid proximity to the container target (example shown in FIG. 1F), additionally or alternatively by closest corner, closest edge, or otherwise ordered. In the objective order it is determined if each empty space is collision free (i.e., item does not extend past the edge of the empty space). Alternately, the empty spaces may be checked to be collision free before they are ordered. An empty space which is collision free may be considered a collision-free-empty space. For the first collision-free-empty space (e.g., first in the objective order), the sub-step outputs the closest location to the item's container target such that the item bounding box fits (inside the collision-free-empty space) as the item destination 180 (this location can be measured from the center of the rectangle as illustrated in FIG. 1G, closest edge, closest corner, etc.).

In a second example, the sub-step identifies the first collision-free-empty space that is at least as large as the item (e.g., length and width and/or length and width rotated 90 degrees, item bounding box dimensions including or excluding the manipulator, etc.). The closest point/region within the collision-free-empty space to the item destination is selected (e.g., output as the item destination).

In some implementations, the sub-step outputs failure if no empty spaces are identified which are collision free (e.g., there are no collision-free-empty spaces). Outputting failure may result in: generating a failure report, stopping the actuation system (e.g., conveyor line), commanding the manipulator to place the item elsewhere, stopping all systems, or any other suitable response.

### Manipulator Planning

In some implementations, the manipulator planning step functions to calculate required motion of the arm to move and orient the manipulator (while holding an item) from the initial position to the item destination.

In some implementations, the data processor performs the manipulator planning step.

In some implementations, the manipulator planning step: occurs before, during, or after the acquisition step; occurs during or after the move step; occurs after the imaging, object detection, and target planning steps; occurs before the execution step. In variation, this step can occur at any suitable time(s) relative to other steps, inputs, or executable tasks.

In one example, the manipulator planning step calculates the required motion in the sensor reference frame. However, manipulator planning can be performed in the robot reference frame, the manipulator reference frame, the container reference frame, and/or any other suitable planning reference frame, wherein the item destination (and/or item pose) can be transformed into the planning reference frame.

In some implementations, the calculated motion is performed by kinematic (e.g., forward or inverse) or dynamic path planning with any suitable controls approach (e.g., linear, non-linear, etc.), or any other suitable manipulator path planning technique. In implementations, the control approach is closed loop, relying on encoders or other sensors to ensure accurate positioning of the manipulator.

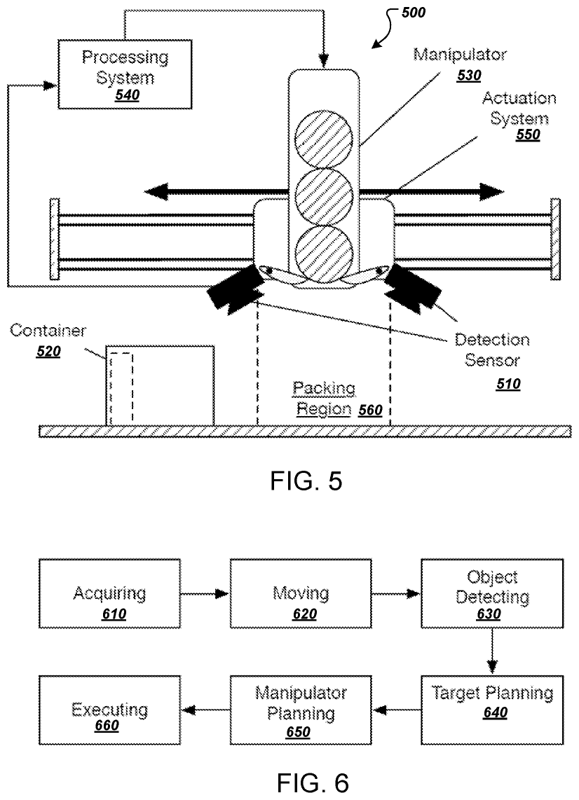

In another variant, the manipulator planning step receives no feedback from the manipulator during the execution step (example shown in FIG. 6). In FIG. 6, the system can perform steps in this order: acquiring (610), moving (620), object detecting (630), target planning (640), manipulator planning (650), and executing (660).

In some variants, a second instance of the imaging, object detecting, target planning, and manipulator planning steps may be called after a first instance of an execution steps. This may be desired in variants where the obstacles and/or item have the potential to shift. In this case, the manipulator planning step modifies the first instance of the manipulator planning step to ensure the manipulator (with the item) arrives at a second item destination.

In a first example, the container is moving continuously on a belt and the manipulator is a robotic arm. The first instance of the manipulator planning step identifies a manipulator path. While the arm is moving, this path is periodically updated to account for shifts in the obstacles and item (example shown in FIG. 4).

In a second example, the container is stationary and the manipulator is a gantry system. The target planning identifies an item destination. The manipulator first moves to position the item vertically above the item destination ((x,y) in the sensor reference frame) and then lowers the item into place. In variation to the second example, the manipulator can release the item without any movement in the z direction.

### Executing

In some implementations, the executing step carries out the manipulator plan, placing the item at the item destination.

In some implementations, the execution step: occurs after the acquiring item step; occurs during or after the actuating step; occurs after the imaging, object detection, and target planning steps, and manipulator planning steps. In variation, this step can occur at any suitable time(s) relative to other steps, inputs, or executable tasks. In a preferred embodiment, the executing step is performed by the manipulator. In a more preferred embodiment, the executing step may be performed by a combination of the manipulator and the processing system.

In some implementations, the processing system carries out the manipulator plan during the executing step by operating the manipulator by closed loop control approach, based on data collected from sensors (e.g., encoders, position sensor, or other suitable sensing devices) monitoring the manipulator (continuously or asynchronously).

In some implementations, the executing step feedback control is based on detection of the manipulator and item by the object detection sensor. In variations of this embodiment, the manipulator planning step further controls motion of the manipulator according to the imaging and object detecting steps sensing and identifying the relative position of the manipulator and item during a first instance of the execution step.

FIG. 7 is a flowchart of an example process for placing an item in a container at a selected item destination. The example process will be described as being performed by a system of one or more computers in one or more locations. For example, the process can be performed by the processing system 340 or 540.

The system samples a container and its contents (705) and determines object regions based on the sampled measurements (710). For example, the system can use an object detection process, e.g., using a depth image map, to identify objects within a container and can define their associated object regions.

The system defines a reference bounding box and a rotated coordinate system based on the object regions (715). In some implementations, the system computes a rotated rectangle that entirely encloses the detected object regions. In some implementations, the system computes a minimum rotated rectangle that encompasses the object regions.

The system determines a container target (720). For example, the system can determine a region or a destination within a container, for example, from a container template.

The system determines an item bounding box in the rotated coordinate system (735). For example, the system can define a bounding box for the item to be placed into the container that is aligned with the rotated coordinate system. In some implementations, the system determines the item bounding box by optionally picking up the item (725) and sampling the item (730).

The system projects a container target into the rotated coordinate system (740). The container target can thus be referenced in the rotated coordinate system to align with any rotation of the container.

The system determines object bounding boxes in the rotated coordinate system (745). For example, the system can determine bounding boxes of objects already in the container that are aligned with the rotated coordinate system.

The system decomposes empty space bounded by object bounding box boundaries into candidate regions aligned with the rotated coordinate system (750). For example, the system can subdivide regions that are not occupied by bounding box boundaries into rectangles of empty space that are aligned with the rotated coordinate system.

The system selects an item destination based on the candidate regions (step 750), projected container target (step 740), and item bounding box (step 735) (755). The item destination can be a point or a region within the container that overlaps with empty spaces and that is large enough for the item bounding box.

The system optionally plans a manipulator path to the selected item destination (760). For example, the system can generate a plan for a robot arm to move the item to the selected item destination.

The system optionally places the item in the selected item destination (765). For example, the system can execute the planned manipulator path to effectuate the item placement within the container.

FIG. 8 is a flowchart of another example process for placing an item in a container at a selected item destination. In this example, the system orders candidate regions by distance from a projected container target. The example process will be described as being performed by a system of one or more computers in one or more locations. For example, the process can be performed by the processing system 340 or 540.

The system can determine a rotated coordinate system based on objects in the container (steps 802-814).

The system optionally images the container (802) and determines a point cloud from the container image (804). From this information, the system can determine a depth map (815) and determine a mesh from the point cloud (808).

The system determines binary mask object regions (810). The binary mask can be a bitmask that indicates where in the image objects are and where there are no objects.

The system finds a minimum rotated rectangle that encompasses object regions in the mask (812) and determines a rotated coordinate system based on the minimum rotated rectangle (814).

The system can determine an item bounding box (steps 816-822) in the rotated coordinate system. To do so, the system can optionally image the item (816) and determine an item mesh in a global coordinate system (818). The global coordinate system can for example be the coordinate system that the sensors are calibrated on.

The system projects the item into the rotated coordinate system (820) and determines an item bounding box in the rotated coordinate system (822). For example, the system can use the rotated coordinate system determined in step 814. Thus, the bounding box of the item will be aligned with an axis in the rotated coordinate system instead of the global coordinate system.

The system can determine candidate regions from objects in the container (steps 824-828).

From the mesh determined from the point cloud (step 808), the system can project objects into the rotated coordinate system (824) and determine object bounding boxes in the rotated coordinate system (826). For example, the system can use the rotated coordinate system determined in step 814.

The system determines candidate regions (828). As described above, the candidate regions can be empty spaces in the container where objects do not already reside.

The system determines a container target for an item (832). In order to do this, the system can optionally learn a container target (825) using a machine learning model.

The system projects the container target into the rotated coordinate system (834).

The system orders candidate regions by increasing distance to the projected container target (836). For example, the system can compute respective distances between each candidate region and the project container target. The system can then order the candidate regions according to their respective computed distances from the projected container target.

The system selects a first candidate region that the item bounding box fits into (840). For example, the closest candidate region to the projected container target may not be large enough for the item according to the bounding box of the item. Thus, the system can next try the second-closest candidate region to the projected container target, and so on, until finding a candidate region that will hold the item according to the bounding box of the item. If no such candidate region is found, the system can raise an error.

The system finds a point closest to the container target within the candidate region that allows the item bounding box to fit (842). In other words, the system can attempt to place the item as close as possible to the container target within the selected candidate region, but some adjustment might be needed.

The system plans a manipulator path to the selected item destination (844) and places the item in the selected item destination (846) according to the planned manipulator path.

### Example Method

At training time, a container with the item placed inside is presented in the object detector view. The container and the item are detected with object detectors, and thus the relative pose of item in container frame is derived

T_{item_box}≡(x⁰,y⁰,z⁰,φ⁰,θ⁰,ψ⁰).

This derived pose can be used as the prior at run time.

At run time, the item pose in hand pose T_{hand}^{item} and container pose in robot base frame T_{box}^{base} are estimated. The output from insert planner is the target hand pose in robot base frame T_{hand}^{base}′. The insert planner can compute the optimized Tᵢₜₑₘ^{box}′ with a prior Tᵢₜₑₘ^{box}. Among all dimensions for the prior (x^{o},y^{o},z^{o},φ^{o},θ^{o},ψ^{o}), x^{o},y^{o} can be determined to correct for collision avoidance.

To determine the target hand pose, the insert planner receives: inputs:

Tᵢₜₑₘ^{hand}, T_{box}^{base}′, {pⱼ^{item}}ᵢ₌₁^{N}ᵢₜₑₘ, {pⱼ^{item}}ᵢ₌₁^{N}_{box}, top-down view depth image D (e.g., of the container, of the item), and the poses and meshes of items already inside the box {T_{obstacle}_{ₖ}^{box},}pⱼ^{item}{ⱼ₌₁^{N}_{obstacle}_{ₖ}}ₖ₌₁^{K}.

The insert planner can output: T_{hand}^{base}′≡(x′,y′,z′,φ′,θ′,ψ′).

To determine the target hand pose, the insert planner can perform the following process.

1. Assign φ′=φ^{o},θ′=θ^{o},ψ′=ψ^{o},z′=z^{o}.

2. Project points of container mesh {pⱼ^{item}}ᵢ₌₁^{N}_{box} onto depth image D to obtain a binary mask M.

3. Find the minimal rotated rectangle covering the binary mask M and use the minimal rotated rectangle's sides as a new u, v coordinate system, thus obtaining the vertices of rotated rectangle and using minimal plus maximal coordinates (μₘ, νₘ, μₘ, νₘ) (e.g., in the container reference frame) for representation.

4. Project the prior x⁰, y⁰ to μ, ν coordinate system to get μ⁰, ν⁰.

5. Project points of item mesh expressed in container frame Tᵢₜₑₘ^{box}·{pⱼ^{item}}ᵢ₌₁^{N}_{box} into μ, ν coordinate system, and obtain the axis-aligned bounding box dimension l,w.

6. Project points of mesh of already existing items in box frame {Tᵢₜₑₘ^{box}·pⱼ^{item}}ᵢ₌₁^{N}_{obstacle}_{ₖ} into μ, ν coordinate system, and obtain their bounding boxes {μ_{m,k},ν_{m,k},μ_{M,k},ν_{M,k}}ₖ₌₁^{K}.

7. Solve for the optimal μ*, ν* with the procedure in Algorithm 1.

Algorithm 1, solving for optimal box center coordinate in 2D space:
Input: μ^{o},ν^{o},{μ_{m,k},ν_{m,k},μ_{M,k},ν_{M,k}}ₖ₌₁^{K},μₘ,νₘ,μ_{M},ν_{M},l,w
Output: optimal {μ*, ν*} closest to {μ⁰,ν⁰} outcome
Order {μ_{m,k},ν_{m,k},μ_{M,k},ν_{M,k},}ₖ₌₁^{K}, μₘ,νₘ,μ_{M},ν_{M} and use them as boundary points.

Find the full set of rectangles defined by the boundary points, and each rectangle is represented as its μ, ν coordinates at two vertices along one diagonal:

[\hat{μ}_{m,i},\hat{ν}_{m,i},\hat{μ}_{M,i},\hat{ν}_{M,i}].

Order the set of rectangles by increasing distance to the prior:

μ^{o},ν^{o},[\tilde{μ}_{m,i},\tilde{ν}_{m,i},\tilde{μ}_{M,i},\tilde{ν}_{M,i}].

i←1

while i<number of candidate rectangles do

if i-th rectangle is collision free then
Find the point closest to the prior {μ⁰,ν⁰} within:
   [\tilde{μ}_{m,i},\tilde{ν}_{m,i},\tilde{μ}_{M,i},\tilde{ν}_{M,i}], such that a l,w sized rectangle fits inside.

return μ*, ν*, success

end if

i←i+1

end while

return μ⁰, ν⁰, failure

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving an image of a container that contains one or more objects;
generating one or more respective masks that define the boundaries of the one or more objects within the container;
determining empty spaces in the container based on the one or more masks, and the bounding box of the mask of an additional object to be placed in the container;
determining a container target within a rotated coordinate system for the additional object;
ordering the empty spaces according to distance from the container target; and
selecting a target empty space for the additional object according to the ordering.

2. The method of claim 1, further comprising determining a bounding box that circumscribes all boundaries of the one or more objects within the container, and
wherein determining the empty spaces comprises determining empty spaces that are within the bounding box.

3. The method of claim 1, wherein determining the empty spaces comprises determining one or more empty axis-aligned rectangles in the rotated coordinate system.

4. The method of claim 1, wherein determining the container target within the rotated coordinate system comprises projecting the additional object into the rotated coordinate system.

5. The method of claim 1, further comprising causing a physical manipulator to place the additional object into the container at the selected target empty space.

6. The method of claim 1, further comprising determining the rotated coordinate system based on a minimum rotated rectangle that encompasses all of the objects within the container.

7. The method of claim 1, wherein generating the one or more respective masks comprises processing point cloud data from the image.

8. The method of claim 1, wherein the container target is based on a packing template for the container.

9. A system comprising:
one or more computers and one or more storage devices storing instructions that are operable, when executed by the one or more computers, to cause the one or more computers to perform operations comprising:
receiving an image of a container that contains one or more objects;
generating one or more respective masks that define the boundaries of the one or more objects within the container;
determining empty spaces in the container based on the one or more masks, and the bounding box of the mask of an additional object to be placed in the container;
determining a container target within a rotated coordinate system for the additional object;
ordering the empty spaces according to distance from the container target; and
selecting a target empty space for the additional object according to the ordering.

10. The system of claim 9, wherein the operations further comprise determining a bounding box that circumscribes all boundaries of the one or more objects within the container, and
wherein determining the empty spaces comprises determining empty spaces that are within the bounding box.

11. The system of claim 9, wherein determining the empty spaces comprises determining one or more empty axis-aligned rectangles in the rotated coordinate system.

12. The system of claim 9, wherein determining the container target within the rotated coordinate system comprises projecting the additional object into the rotated coordinate system.

13. The system of claim 9, further comprising causing a physical manipulator to place the additional object into the container at the selected target empty space.

14. The system of claim 9, wherein the operations further comprise determining the rotated coordinate system based on a minimum rotated rectangle that encompasses all of the objects within the container.

15. The system of claim 9, wherein generating the one or more respective masks comprises processing point cloud data from the image.

16. The system of claim 9, wherein the container target is based on a packing template for the container.

17. One or more non-transitory computer storage media encoded with computer program instructions that when executed by one or more computers cause the one or more computers to perform operations comprising:
receiving an image of a container that contains one or more objects;
generating one or more respective masks that define the boundaries of the one or more objects within the container;
determining empty spaces in the container based on the one or more masks, and the bounding box of the mask of an additional object to be placed in the container;
determining a container target within a rotated coordinate system for the additional object;
ordering the empty spaces according to distance from the container target; and
selecting a target empty space for the additional object according to the ordering.

18. The one or more computer storage media of claim 17, wherein the operations further comprise determining a bounding box that circumscribes all boundaries of the one or more objects within the container, and
wherein determining the empty spaces comprises determining empty spaces that are within the bounding box.

19. The one or more computer storage media of claim 17, wherein determining the empty spaces comprises determining one or more empty axis-aligned rectangles in the rotated coordinate system.

20. The one or more computer storage media of claim 17, wherein determining the container target within the rotated coordinate system comprises projecting the additional object into the rotated coordinate system.
